(19) United States
(12) Patent Application Publication
(10) Pub. No.: US 2026/0194101 A1
(43) Pub. Date: Jul. 9, 2026

(54) COUNTERWEIGHT SCREW

(71) Applicant: Dongguan Huaruida Hardware Co., Ltd., Dongguan (CN)

(72) Inventor: RUIHUI LI, Dongguan (CN)

(21) Appl. No.: 19/556,189

(22) Filed: Mar. 4, 2026

(30) Foreign Application Priority Data
Dec. 22, 2025 (CN) 202522707007.3

(51) Int. Cl. F16B 35/00; A63B 53/04; A63B 53/08

(52) U.S. Cl. CPC F16B 35/00; A63B 53/08; A63B 2053/0491

(57) ABSTRACT

Provided is a counterweight screw, which includes a screw body and a counterweight block that can be embedded in or separated from the screw body. A density of the counterweight block is greater than that of the screw body. An outer circumference of the screw body is provided with external threads, and the external threads are arranged around a circumference of the screw body. The screw body has a non-circular recess, and the counterweight is embedded in the recess. The counterweight block can play a role in weight distribution, and the counterweight screw does not need to be made of high-density rare metals as a whole, thereby greatly reducing costs. There is no need for complex processing of the counterweight block, and the processing of the screw body will not cause excessive damage to the cutting tool, thus simplifying the processing technology.

### CROSS-REFERENCE TO RELATED APPLICATIONS

This application claims priority to Chinese Patent Application No. 202522707007.3, filed on December 22, 2025, which is hereby incorporated by reference in its entirety.

### TECHNICAL FIELD

The present disclosure relates to the field of screw technologies, and in particular, to a counterweight screw.

### BACKGROUND

The counterweight screw is a key component that optimizes equipment performance or stability by adjusting weight distribution, and its specific use varies depending on the application field. For example, when used in golf clubs, counterweight screws can act as “adjusters” of the club, affecting the hitting effect by changing the center of gravity position of the club head.

In existing technology, the counterweight screw is formed as a whole from a single high-density material through powder metallurgy technology, or made by casting/machining a single material. The density and weight of the counterweight screw completely depend on the raw material itself.

The existing counterweight screws have the following defects.

1. High material cost: the overall use of high-density rare metals makes the material unit price expensive.

2. High processing difficulty: high-density rare metals cause serious tool wear and require precision machining to ensure overall dimensional accuracy.

3. Strict requirements for density stability: if the material density is uneven, it will cause weight deviation of the counterweight screws, thereby affecting the counterweight accuracy.

### SUMMARY

The purpose of the present disclosure is to provide a counterweight screw, aiming to solve the problem of high cost of counterweight screws in the prior art.

The present disclosure is implemented as follows: a counterweight screw, including: a screw body and a counterweight block that is configured to be embedded in or separated from the screw body, where a density of the counterweight block is greater than that of the screw body; an outer circumference of the screw body is provided with external threads, and the external threads are arranged around a circumference of the screw body; the screw body is provided with a non-circular recess, and the counterweight block is embedded in the recess and integrated with the screw body.

In some embodiments of the present disclosure, the screw body includes an end head and a connection section, a diameter of the end head is larger than that of the connection section, the external threads are provided on an outer circumference of the connection section, and the recess is formed in the connection section.

In some embodiments of the present disclosure, along a length direction of the connection section, the connection section sequentially includes a straight cylindrical rear end section, a threaded section, and a front end section; the external threads are formed on an outer circumference of the threaded section, the rear end section is docked with the end head, and the recess is formed in the front end section.

In some embodiments of the present disclosure, the recess extends into the threaded section.

In some embodiments of the present disclosure, the end head is provided with an installation groove, and the installation groove is arranged away from the recess.

In some embodiments of the present disclosure, the screw body is integrally formed, the counterweight block is made of tungsten alloy, and the screw body is made of stainless steel.

In some embodiments of the present disclosure, the recess is rectangular, and the counterweight block is rectangular.

In some embodiments of the present disclosure, an outer circumference of the counterweight block has an outer ring side wall arranged in a surrounding manner, and the outer ring side wall is sleeved with two layers of elastic film layers arranged in a surrounding manner; the two layers of elastic film layers are arranged at intervals along a thickness direction of the counterweight block; the elastic film layers have multiple hollow grooves in a shape of strip, and the multiple hollow grooves are arranged at intervals along a circumference of the outer ring side wall;

the hollow grooves extend along a thickness direction of the outer ring side wall, and the hollow grooves of the two layers of elastic film layers are arranged in a staggered manner; an outer circumference of the recess has an inner ring side wall, and the elastic film layers on two sides are respectively in contact with the inner ring side wall, and the elastic film layers are in a compressed deformation state.

In some embodiments of the present disclosure, a central through-hole is provided at a center position of the counterweight block, and the central through-hole is arranged in a through manner along the thickness direction of the counterweight block; the recess is provided with a fixing ring that is configured to be embedded in or detached from the recess, and the fixing ring is surrounded to form a circular area;

the circular area is provided with multiple radial bars, and the radial bars are arranged around a circumference of the fixing ring; one end of the radial bars is connected to the fixing ring, and the other end of the multiple radial bars is gathered and connected to form a central position;

the central position is connected to a central axis, and an outer circumference of the fixing ring is covered with an elastic fixed film layer; the fixing ring is embedded in the recess, the fixed film layer is pressed against the inner ring side wall, the central axis is passed through the central through-hole, and the fixing ring is pressed against the counterweight block.

In some embodiments of the present disclosure, an outer circumference of the central axis is provided with multiple elastic rings, and the elastic rings are arranged at intervals along a length direction of the central axis, and the elastic rings are in contact with a wall of the central through-hole.

Compared with the existing technology, the counterweight screw provided by the present disclosure has the following technical advantages:

1. Using the counterweight block embedded in the screw body, and the density of the counterweight block is greater than that of the screw body, the counterweight block can play a role in balancing. The counterweight block can be made of high-density rare metals, such as tungsten alloy, while the screw body can be made of conventional metals, such as stainless steel. The counterweight screw does not need to be made entirely of high-density rare metals, greatly reducing costs.

2. There is no need for complex processing of the counterweight block, and the processing of the screw body will not cause excessive wear and tear on the cutting tool. Using ordinary equipment can ensure overall dimensional accuracy and simplify the processing technology.

3. The counterweight block can be separated from the screw body, so that according to the weight requirements, different weights of counterweight blocks can be corresponding to meet different weight requirements. The weight of the counterweighting is determined by the counterweight block, without the need to maintain the material uniformity of the screw body, thereby greatly reducing costs.

### BRIEF DESCRIPTION OF DRAWINGS

FIG. 1 is a schematic sectional view of a counterweight screw provided by the present disclosure.

FIG. 2 is a schematic sectional view of a screw body provided by the present disclosure.

FIG. 3 is a schematic sectional view of a counterweight block provided by the present disclosure.

FIG. 4 is a schematic front view of the counterweight block provided by the present disclosure.

FIG. 5 is a schematic sectional view of a fixing ring provided by the present disclosure.

FIG. 6 is a schematic front view of the fixing ring provided by the present disclosure.

FIG. 7 is a schematic sectional view of the counterweight screw provided by the present disclosure.

FIG. 8 is a schematic front view of a central axis provided by the present disclosure.

### DESCRIPTION OF EMBODIMENTS

In order to further clarify the purpose, technical solution, and advantages of the present disclosure, the following will provide a detailed explanation of the present disclosure in combination with the accompanying drawings and embodiments. It should be understood that the specific embodiments described herein are only used to explain the present disclosure and are not intended to limit the present disclosure.

The following provides a detailed description of the implementation of the present disclosure in combination with specific embodiments.

The same or similar reference numbers in the accompanying drawings of this embodiment correspond to the same or similar components. In the description of the present disclosure, it should be understood that if there are terms such as “up”, “down”, “left”, “right” indicating orientation or positional relationships based on the orientation or positional relationships shown in the accompanying drawings, it is only for the convenience of describing the present disclosure and simplifying the description, and does not indicate or imply that the device or component referred to must have a specific orientation, be constructed and operated in a specific orientation. Therefore, the language used to describe positional relationships in the accompanying drawings is only for illustrative purposes and cannot be understood as a limitation of the present disclosure. For those skilled in the art, the specific meanings of the above terms can be understood according to specific situations.

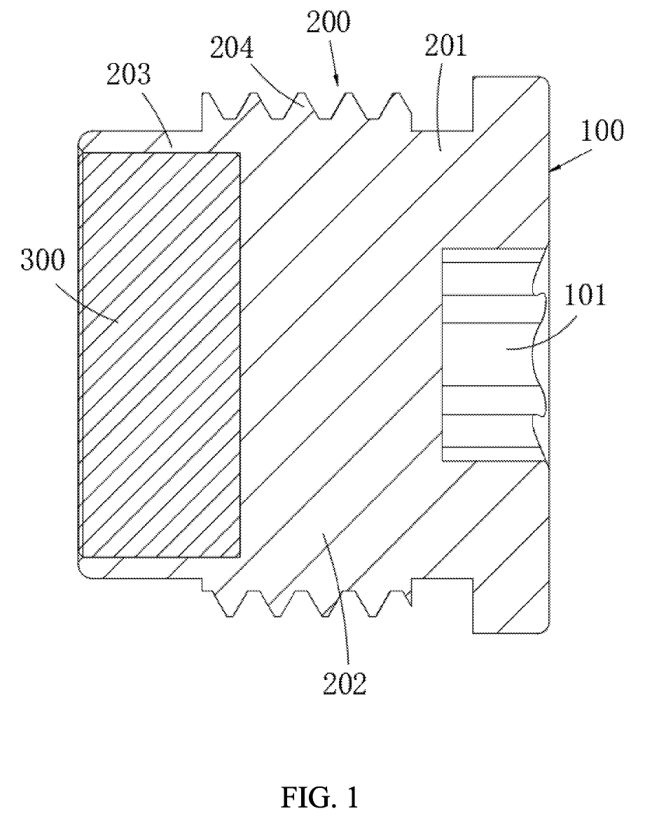

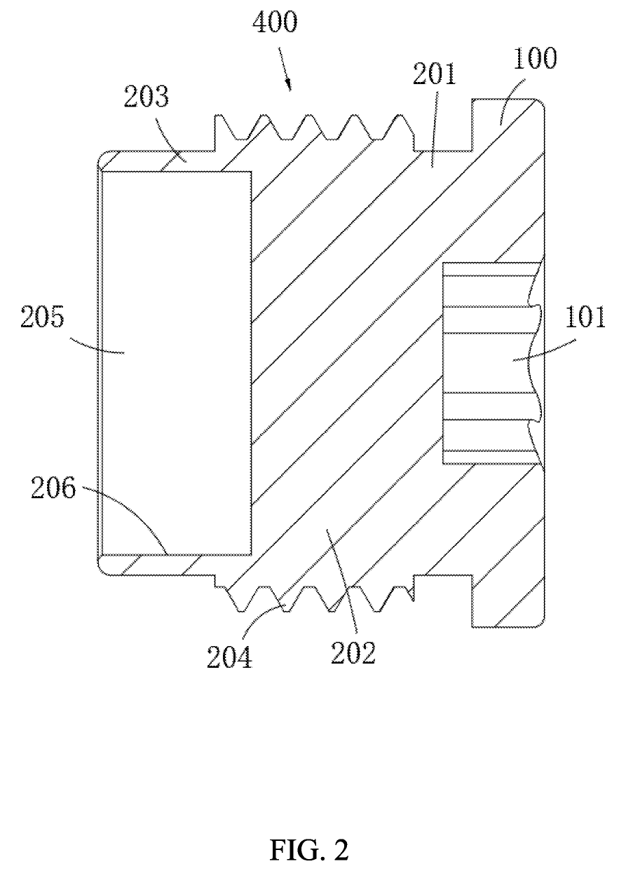

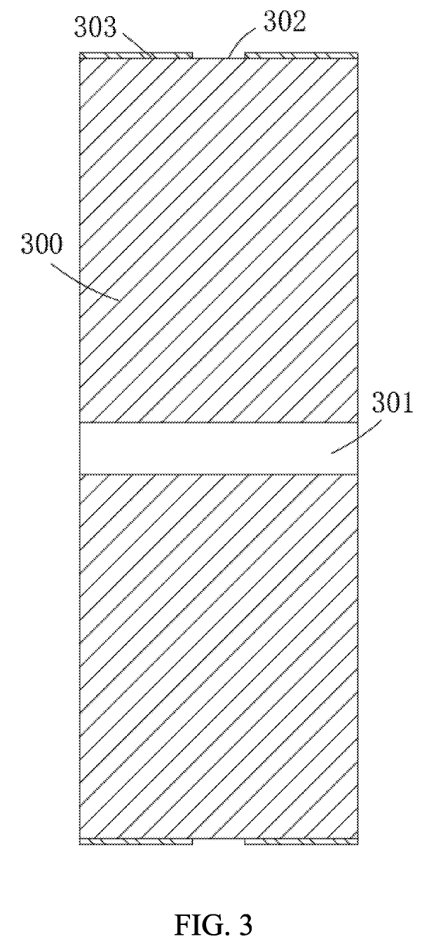

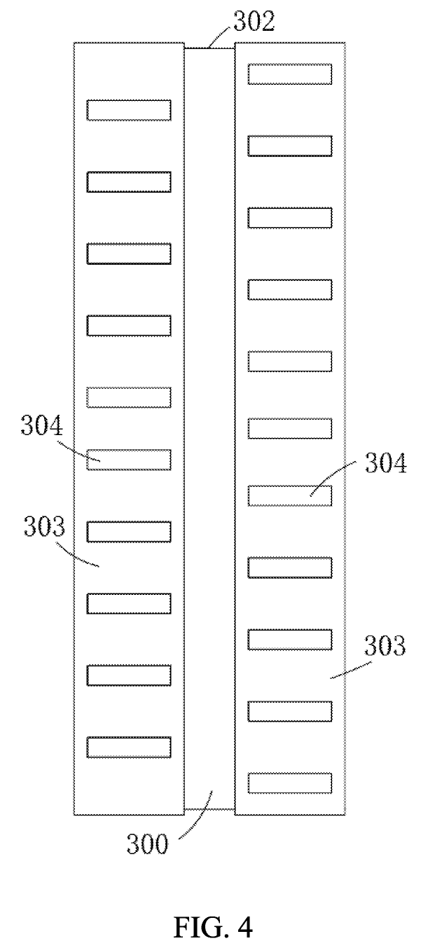

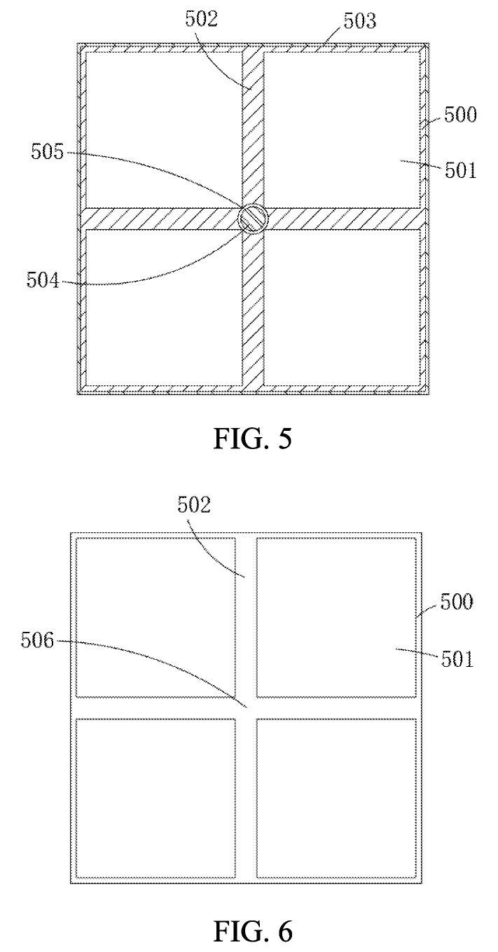

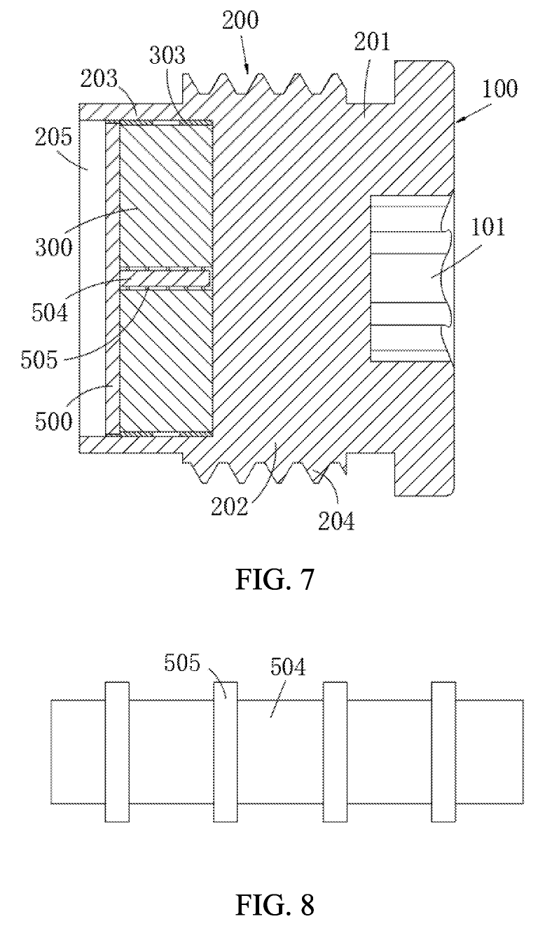

Referring to FIGS. 1-8, an embodiment provided by the present disclosure is shown.

A counterweight screw includes a screw body 400 and a counterweight block 300. The counterweight block 300 can be embedded in the screw body 400 to achieve weight balancing of the screw body 400, or the counterweight block 300 can be separated from the screw body 400 and different weights of counterweight blocks 300 can be embedded in the screw body 400 according to different needs.

A density of the counterweight block 300 is greater than that of the screw body 400, and an outer circumference of the screw body 400 is provided with external threads 204, and the external threads 204 are arranged around a circumference of the screw body 400; the screw body 400 is provided with a non-circular recess 205, and the counterweight block 300 is embedded in the recess 205, and integrated with the screw body 400.

The screw body 400 is connected to external devices such as golf clubs through the external threads 204. The recess 205 has a non-circular shape, and the counterweight block 300 matches the recess 205. In this way, after the counterweight block 300 is embedded in the recess 205, it is fixedly connected to the screw body 400.

The above-mentioned counterweight screws have the following technical advantages.

1. The counterweight block 300 is embedded in the screw body 400, and the density of the counterweight block 300 is higher than that of the screw body 400. The counterweight block 300 can play a role in weight distribution. The counterweight block 300 can be made of high-density rare metals, such as tungsten alloy, while the screw body 400 can be made of conventional metals, such as stainless steel. The counterweight screw does not need to be made of high-density rare metals, thereby greatly reducing costs.

2. There is no need for complex processing of the counterweight block 300, and the processing of the screw body 400 will not cause excessive wear and tear on the cutting tools. Using ordinary equipment can ensure overall dimensional accuracy and simplify the processing technology.

3. The counterweight block 300 can be separated from the screw body 400, so that according to the weight requirements, different weights of counterweight blocks 300 can be corresponding to meet different weight requirements. The weight of counterweighting is determined by the counterweight block 300, without the need to maintain the material uniformity of the screw body 400, thereby greatly reducing costs.

In this embodiment, when the counterweight block 300 is embedded in the recess 205, the counterweight block 300 and the screw body 400 remain fixed, so that an outer circumference size of the counterweight block 300 matches an outer circumference size of the recess 205. Different thicknesses can be set for counterweight blocks 300 of different weights.

In this embodiment, the screw body 400 includes an end head 100 and a connection section 200. A diameter of the end head 100 is larger than that of the connection section 200. The external threads 204 are arranged on an outer circumference of the connection section 200, and the recess 205 is formed in the connection section 200.

The counterweight screw is threaded to the external device through the connection section 200, and the end head 100 can be operated to achieve threaded connection between the connection section 200 and the external device.

In this embodiment, along a length direction of the connection section 200, the connection section 200 sequentially includes a straight cylindrical rear end section 201, a threaded section 202, and a front end section 203. The external threads 204 are formed on an outer circumference of the threaded section 202, and the rear end section 201 is docked with the end head 100. The recess 205 is formed in the front end section 203. In this way, the structure of the screw body 400 can be simplified, and the external threads 204 of the threaded section 202 can be directly connected to the external device through threading.

In this embodiment, the recess 205 extends into the threaded section 202, which can deepen a depth of the recess 205, so that the recess 205 can be embedded and matched with different thicknesses of counterweight blocks 300 to achieve different weight distribution and meet different weight requirements.

In this embodiment, the end head 100 is provided with an installation groove, and the installation groove is arranged away from the recess 205. The installation groove can adopt a hexagonal shape. In this way, by embedding a hexagonal tool into the installation groove, the counterweight screw can be rotated to connect the counterweight screw with the external device by threaded connection or detach it from the external device.

In this embodiment, the screw body 400 is integrally formed and can be processed as a whole to form the screw body 400, and the counterweight block 300 can be made of high-density tungsten alloy through powder metallurgy or machining.

In this embodiment, the recess 205 is rectangular in shape, and the counterweight block 300 is rectangular in shape to fix the counterweight block 300 in the recess 205. In this way, when the counterweight block 300 is embedded in the recess 205, it is fixedly connected to the screw body 400 to achieve accurate weight distribution.

In an implementation mode, the outer circumference of the counterweight block 300 has an outer ring side wall 302 arranged in a surrounding manner, and the outer ring side wall 302 is sleeved with two layers of elastic film layers 303 arranged in a surrounding manner. Along a thickness direction of the counterweight block 300, two layers of elastic film layers 303 are arranged at intervals. The elastic film layers 303 have multiple hollow grooves 304 in the shape of strip, and the hollow grooves 304 are arranged around a circumference side of the outer ring side wall 302 at intervals.

The hollow grooves 304 extend along a thickness direction of the outer ring side wall 302, and the hollow grooves 304 of the two layers of elastic film layers 303 are arranged in a staggered manner. An outer circumference of recess 205 has an inner ring side wall 206, and the elastic film layers 303 on two sides are respectively in contact with the inner ring side wall 206, and the elastic film layers 303 are in a compressed deformation state.

By arranging the elastic film layers 303, and the elastic film layers 303 are in an elastic compression deformation state, the counterweight block 300 is stabilized in the recess 205, and a circumferential elastic connection of the counterweight block 300 is achieved, thereby achieving vibration buffering of the counterweight block 300 and achieving better weight distribution effect.

Secondly, the elastic film layers 303 can provide protection to the outer ring side wall 302 of the counterweight block 300, thus avoiding cracking or damage to the counterweight block 300 after prolonged use.

In an implementation mode, the elastic film layers 303 are provided with hollow grooves 304, which can increase the circumferential elastic deformation ability of the elastic film layers 303. When the counterweight block 300 is embedded in the recess 205, it facilitates the elastic deformation of the elastic film layers 303, so that the counterweight block 300 is firmly placed in the recess 205.

By arranging two layers of spaced elastic film layers 303, it is possible to achieve better embedding of the counterweight block 300 in the recess 205 and better elastic connection.

Furthermore, a center position 506 of the counterweight block 300 is provided with a central through-hole 301, which is arranged to pass through along the thickness direction of the counterweight block 300. The recess 205 is provided with a fixing ring 500 that can be embedded in or detached from the recess 205, and the fixing ring 500 surrounds to form a circular area 501.

The circular area 501 is provided with multiple radial bars 502, and the radial bars 502 are arranged around the fixing ring 500 in a circumferential direction. One end of the radial bars 502 is connected to the fixing ring 500, and the other end of the radial bars 502 is connected together to form the central position 506.

The central position 506 is connected to a central axis 504, and an outer circumference of the fixing ring 500 is covered with an elastic fixed film layer 503. The fixing ring 500 is embedded in the recess 205, and the fixed film layer 503 is pressed against the inner ring side wall 206. The central axis 504 is inserted into the central through-hole 301, and the fixing ring 500 is pressed against the counterweight block 300.

After the counterweight block 300 is embedded in the recess 205, the counterweight block 300 is elastically connected between the elastic film layers 303 and the recess 205, and the fixing ring 500 can axially press the counterweight block 300 to make the counterweight block 300 to be stable in the recess 205.

By arranging the central axis 504, and the central axis 504 passes through the central through-hole 301, a center of the counterweight block 300 can be positioned. The counterweight block 300 is in a vibration environment, and elastic buffering can be achieved in the recess 205, while maintaining the center position 506 of the counterweight block 300 in a reset position, avoiding the phenomenon of excessive displacement of the center position 506 of the counterweight block 300 after long-term use.

By using multiple radial bars 502 to limit the position of the central axis 504, the position of the central axis 504 can be further maintained to achieve the limitation of the center position 506 of the counterweight block 300.

An outer circumference of the fixing ring 500 is covered with a fixed film layer 503, which can make the fixing ring 500 to be stable in the recess 205 and has circumferential elastic properties, which can achieve vibration buffering of the fixing ring 500.

Furthermore, an outer circumference of the central axis 504 is provided with multiple elastic rings 505, and the elastic rings 505 are arranged at intervals along a length direction of the central axis 504. The elastic rings 505 are in contact with a wall of the central through-hole 301. In this way, vibration buffering can be achieved between the central axis 504 and the counterweight block 300 so as to achieve better positioning of the central axis 504 at the center position 506 of the counterweight block 300.

The above description is only a preferred embodiment of the present disclosure and is not intended to limit the present disclosure. Any modifications, equivalent substitutions, and improvements made within the spirit and principles of the present disclosure should be included within the protection scope of the present disclosure.

What is claimed is:

1. A counterweight screw, comprising: a screw body and a counterweight block that is configured to be embedded in or separated from the screw body,
wherein a density of the counterweight block is greater than that of the screw body; an outer circumference of the screw body is provided with external threads, and the external threads are arranged around a circumference of the screw body; the screw body is provided with a non-circular recess, and the counterweight block is embedded in the recess and integrated with the screw body.

2. The counterweight screw according to claim 1, wherein the screw body comprises an end head and a connection section, a diameter of the end head is larger than that of the connection section, the external threads are provided on an outer circumference of the connection section, and the recess is formed in the connection section.

3. The counterweight screw according to claim 2, wherein along a length direction of the connection section, the connection section sequentially comprises a straight cylindrical rear end section, a threaded section, and a front end section; the external threads are formed on an outer circumference of the threaded section, the rear end section is docked with the end head, and the recess is formed in the front end section.

4. The counterweight screw according to claim 3, wherein the recess extends into the threaded section.

5. The counterweight screw according to claim 2, wherein the end head is provided with an installation groove, and the installation groove is arranged away from the recess.

6. The counterweight screw according to claim 1, wherein the screw body is integrally formed, the counterweight block is made of tungsten alloy, and the screw body is made of stainless steel.

7. The counterweight screw according to claim 1, wherein the recess is rectangular, and the counterweight block is rectangular.

8. The counterweight screw according to claim 1, wherein an outer circumference of the counterweight block has an outer ring side wall arranged in a surrounding manner, and the outer ring side wall is sleeved with two layers of elastic film layers arranged in a surrounding manner; the two layers of elastic film layers are arranged at intervals along a thickness direction of the counterweight block; the elastic film layers have multiple hollow grooves in a shape of strip, and the multiple hollow grooves are arranged at intervals along a circumference of the outer ring side wall;
the hollow grooves extend along a thickness direction of the outer ring side wall, and the hollow grooves of the two layers of elastic film layers are arranged in a staggered manner; an outer circumference of the recess has an inner ring side wall, and the elastic film layers on two sides are respectively in contact with the inner ring side wall, and the elastic film layers are in a compressed deformation state.

9. The counterweight screw according to claim 8, wherein a central through-hole is provided at a center position of the counterweight block, and the central through-hole is arranged in a through manner along the thickness direction of the counterweight block; the recess is provided with a fixing ring that is configured to be embedded in or detached from the recess, and the fixing ring is surrounded to form a circular area;
the circular area is provided with multiple radial bars, and the radial bars are arranged around a circumference of the fixing ring; one end of the radial bars is connected to the fixing ring, and the other end of the multiple radial bars is gathered and connected to form a central position;
the central position is connected to a central axis, and an outer circumference of the fixing ring is covered with an elastic fixed film layer; the fixing ring is embedded in the recess, the fixed film layer is pressed against the inner ring side wall, the central axis is passed through the central through-hole, and the fixing ring is pressed against the counterweight block.

10. The counterweight screw according to claim 9, wherein an outer circumference of the central axis is provided with multiple elastic rings, and the elastic rings are arranged at intervals along a length direction of the central axis, and the elastic rings are in contact with a wall of the central through-hole.
